(19) United States
(12) Patent Application Publication
(10) Pub. No.: US 2016/0291583 A1
(43) Pub. Date: Oct. 6, 2016

(54) NUMERICAL CONTROLLER HAVING PROGRAM DISPLAY FUNCTION USING A PLURALITY OF IMAGES

(71) Applicant: FANUC Corporation, Minamitsuru-gun (JP)

(72) Inventor: Yoshikazu SATAKE, Minamitsuru-gun (JP)

(21) Appl. No.: 15/084,545

(22) Filed: Mar. 30, 2016

(30) Foreign Application Priority Data
Apr. 1, 2015 (JP) 2015-074797

(51) Int. Cl. G05B 19/4155

(52) U.S. Cl. CPC G05B 19/4155; G05B 2219/31472

(57) ABSTRACT

A numerical controller stores data related to a machining program and a plurality of image data in a state where the data related to the machining program and the image data related to machining control are associated with each other, displays the associated data on a display unit, and instructs to switch the displayed image data in a predetermined cycle.

### BACKGROUND OF THE INVENTION

1. Field of the Invention

The present invention relates to a numerical controller and especially relates to a numerical controller having a program display function which facilitates judgment of contents of machining programs.

2. Description of the Related Art

A numerical controller is provided with a function to display information about a machining program for selection of a machining program required for machining among a plurality of machining programs which are stored in a memory, an external device, or the like. In a list display screen or a detail display screen of machining programs based on the display function, program names, comments, update dates and time, and the like of respective machining programs are displayed so as to enable a user to easily find a target machining program.

Further, a numerical controller which is capable of displaying texts of machining programs and displaying tool paths and images of workpieces based on the machining programs so as to enable a user to easily judge a needed machining program is disclosed, as a prior art technique (refer to Japanese Patent Application Laid-Open No. 04-251305, for example).

However, though it is possible to grasp an outline or the like of a machining program from a program name, a comment, and an update date and time, it is difficult to grasp a content of the machining program such as what kind of machining is actually performed.

Further, even though a text of a machining program is displayed on a screen, a content of machining does not become clear until the machining program is analyzed and thus, it is difficult to quickly judge a machining content from the displayed text. Furthermore, even though a tool path or an image is merely shown, it is impossible to grasp a minor difference of programs such as a machining order. Furthermore, a display region is limited, so that it is impossible to display many images and thus, enough judgment materials for grasping machining contents are not provided.

### SUMMARY OF THE INVENTION

An object of the present invention is to provide a numerical controller which has a program display function enabling instantaneous judgment of a content of a machining program.

A numerical controller according to a first aspect of the present invention has a function of displaying a machining program and includes: a machining program data storage region which stores data related to the machining program and a plurality of image data related to machining control based on the machining program in a manner such that the data related to the machining program and the image data related to machining control are associated with each other; a machining program display unit which displays data which is related to the machining program and is stored in the machining program data storage region and at least one of the image data which are associated with the machining program; and a display switch instruction unit which instructs to switch the image data displayed on the machining program display unit in a predetermined cycle. The machining program display unit is configured to switch image data displayed in response to an instruction from the display switch instruction unit.

A numerical controller according to a second aspect of the present invention has a function of displaying a list of a machining program and includes: a machining program data storage region which stores data related to the machining program and a plurality of image data related to machining control based on the machining program in a manner such that the data related to the machining program and the image data related to machining control are associated with each other; a machining program list display unit which displays a list of data which is related to the machining program and is stored in the machining program data storage region and at least one of image data which are associated with the machining program; and a display switch instruction unit which instructs to switch the image data displayed on the machining program list display unit in a predetermined cycle. The machining program list display unit is configured to switch image data displayed in response to an instruction from the display switch instruction unit.

A cycle for switching the image data may further be stored in the machining program data storage region in a state where it is associated with the machining program, and the display switch instruction unit may instruct to switch the image data displayed in the machining program list display unit based on the cycle for switching the image data which is associated with the machining program.

The image data may be image data of a workpiece which is machined based on the machining program, image data of a tool path which is controlled by the machining program, or image data of an object which is controlled by the machining program.

According to the present invention, a numerical controller which has a program display function and by which even an operator who is not familiar with a machining program can grasp contents of machining only by looking at an animation image created by a plurality of images so as to be able to quickly judge a needed machining program can be provided.

### BRIEF DESCRIPTION OF THE DRAWINGS

The forgoing and other objects and feature of the invention will be apparent from the following description of preferred embodiments of the invention with reference to the accompanying drawings, in which:

FIG. 1A and FIG. 1B illustrate an outline of a machining program display function provided to a numerical controller according to the present invention, in which FIG. 1A illustrates an example of a list display screen of machining programs and FIG. 1B illustrates a display on a column of one machining program (O0002) in the screen of FIG. 1A in a time-series order;

FIG. 2 is a functional block diagram illustrating a numerical controller according to an embodiment of the present invention;

FIG. 3 illustrates an example of information related to a machining program which is stored in a machining program information storage region in the numerical controller of FIG. 2; and

FIG. 4 illustrates an example of a display management table which is created on a memory of the numerical controller of FIG. 2.

### DETAILED DESCRIPTION OF THE PREFERRED EMBODIMENT

A numerical controller according to the present invention stores necessary and enough information for achieving selection of a machining program in forms of a plurality of images in a manner such that the information is associated with the machining programs. The numerical controller displays the images with file names and the like of the machining programs on a machining program display screen while periodically switching displayed images so as to enable grasp of machining contents of the machining programs at a glance.

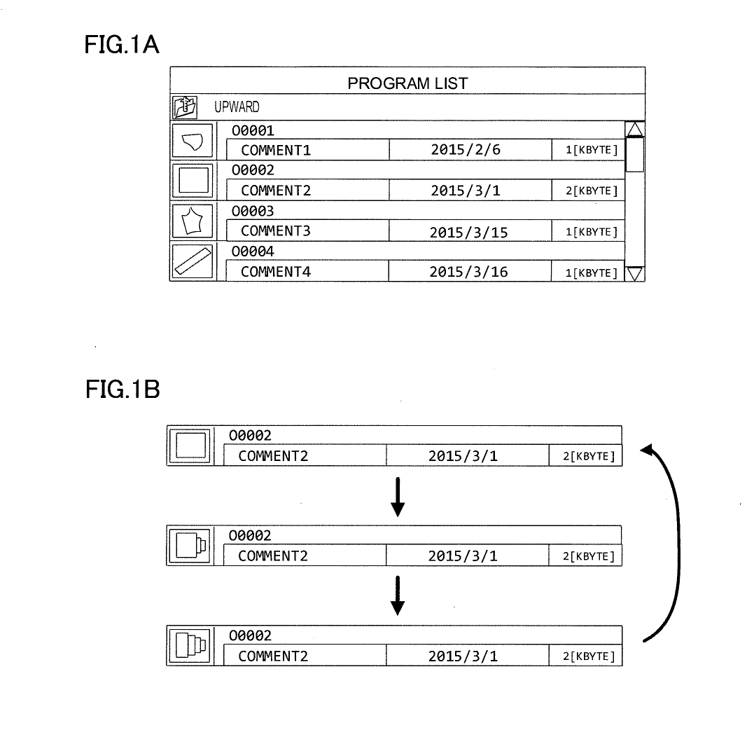

For example, in addition to program names of machining programs (O0001, O0002, O0003, O0004), comments (COMMENT1, COMMENT2, COMMENT3, COMMENT4), creation dates (2015/2/6, 2015/3/1, 2015/3/15, 2015/3/16), and sizes (1 [KBYTE], 2 [KBYTE], 1 [KBYTE], 1 [KBYTE]), images of workpieces which are machined based on corresponding machining programs are displayed as icons on a list display screen of machining programs, as illustrated in FIG. 1A. Each of the machining programs is stored in a state where it is associated with a plurality of images showing stepwise change of a shape of a workpiece which is machined based on the corresponding machining program.

FIG. 1B illustrates a display on a column of a specific machining program O0002 in a time-series order among a plurality of machining programs illustrated in FIG. 1A. As illustrated in FIG. 1B, during display of pieces of information of machining programs on the machining program list display screen, images which are stored in a manner to be associated with these machining programs are displayed while being sequentially switched in each predetermined cycle, in the present invention. A user looking at such display can grasp information such as an order of machining of a workpiece based on the machining program in comparison with a case where the user looks at simple still images, so that the user can quickly judge a needed machining program.

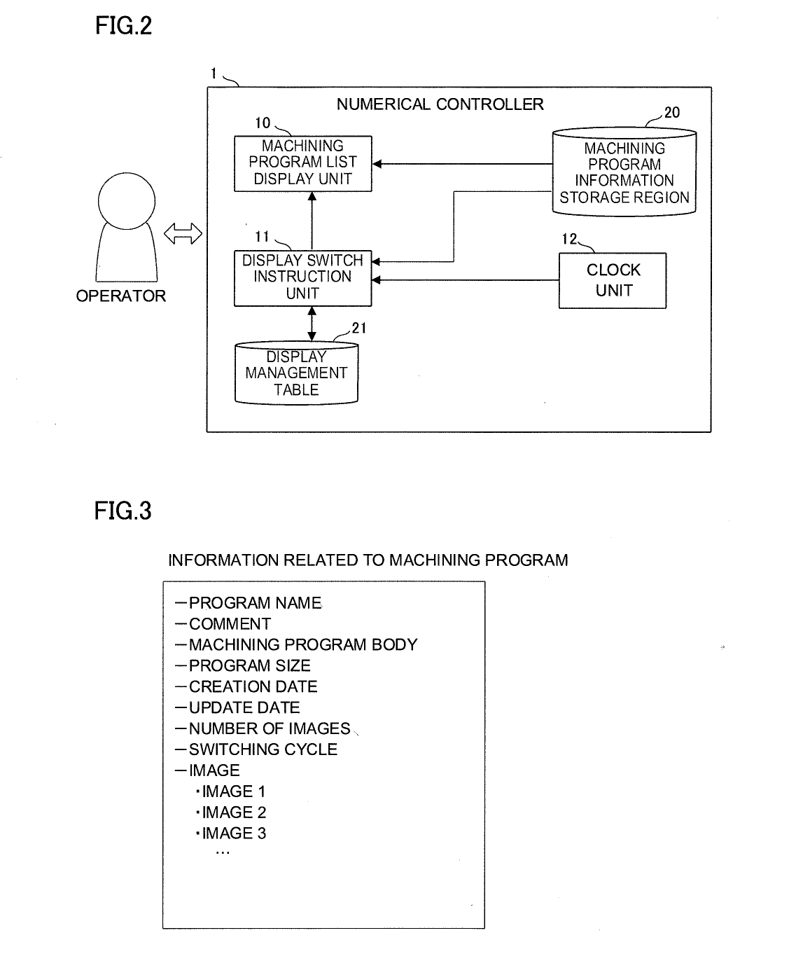

FIG. 2 is a functional block diagram illustrating a numerical controller according to an embodiment of the present invention.

A numerical controller 1 includes a machining program list display unit 10, a display switch instruction unit 11, a clock unit 12, and a machining program information storage region 20 which stores information related to each machining program.

The machining program list display unit 10 displays information related to machining programs which are stored in the machining program information storage region 20 as a list on a display screen of the numerical controller in response to a machining program list display operation performed by a user in reading of a machining program, for example.

FIG. 3 illustrates an example of information related to a machining program which is stored in the machining program information storage region 20.

In the machining program information storage region 20, for each machining program, data such as a plurality of pieces of image data, the number of images, and a switching cycle of image display are stored together with data related to the machining program such as a machining program body, a program name, a comment, a program size, a creation date of the machining program, and an update date of the machining program, in a manner such that they are associated with the machining program. A plurality of pieces of image data are managed in a state where they are provided with identification information which enables grasp of an order, such as image 1, image 2, . . . , for each machining program with which the pieces of image data are associated.

A plurality of pieces of image data which are stored in a state where they are associated with a machining program stored in the machining program information storage region 20 are a plurality of pieces of image data related to machining control based on the machining program. More specifically, such a plurality of pieces of image data are a plurality of pieces of image data of a workpiece which is machined by control based on the machining program, a plurality of pieces of image data of a tool path controlled by the machining program, a plurality of pieces of image data of a control object (a robot, a tool, a machine, or the like) which is controlled by the machining program, and the like. These pieces of image data may be created from images which are taken with a camera or the like at proper timing by a user in execution of test machining based on the machining program or may be created from images in execution of simulation based on the machining program. As for the number of images and the image display switching cycle, proper values may be set when the created pieces of image data are stored in a state where they are associated with a machining program.

The machining program list display unit 10 displays a part of information related to machining programs which are stored in the machining program information storage region 20, in the form of a list, based on display setting set in the numerical controller 1. For example, in the example illustrated in FIG. 1A, the machining program list display unit 10 displays a list of a program name, a comment, a creation date, a program size, and one of a plurality of pieces of image data.

The display switch instruction unit 11 instructs the machining program list display unit 10 to switch pieces of image data of respective machining programs which are listed in a predetermined cycle.

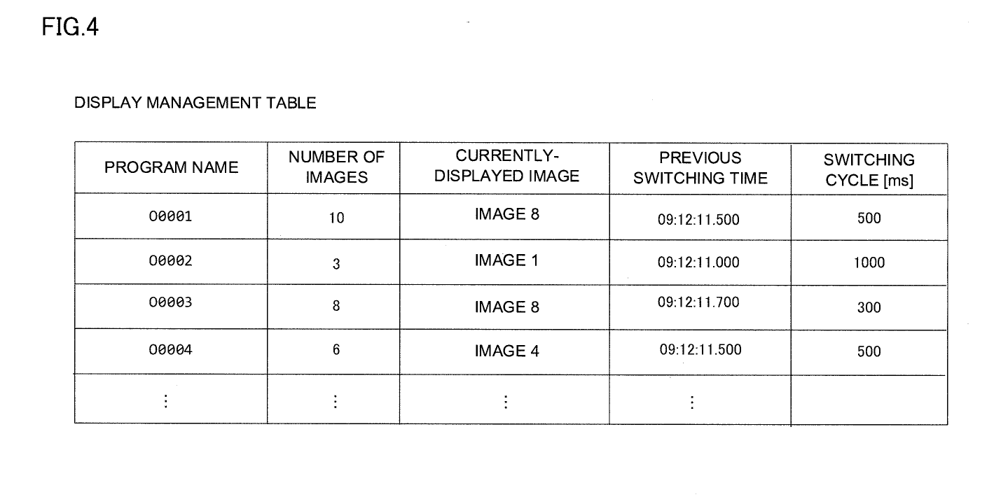

When a list of information related to machining programs is displayed by the machining program list display unit 10, the display switch instruction unit 11 approximately simultaneously creates a display management table 21, as illustrated in FIG. 4, on a memory of the numerical controller 1 based on information acquired from the machining program information storage region 20.

The display management table 21 is a table for managing a display state of each of the machining programs which are displayed by the machining program list display unit 10. In the display management table 21, for each of the machining programs which are stored in the machining program information storage region 20, information of previous switching time, a switching cycle, a currently-displayed image, the number of images, and the like is managed in a manner such that they are associated with each program name.

Displayed in a column of “previous switching time” is a time at which the previous switching is instructed with respect to images of machining programs displayed by the machining program list display unit 10. In the column of “previous switching time”, a time at which machining programs are displayed by the machining program list display unit 10 is set at time when the display management table 21 is created. Set in a column of “switching cycle” is a cycle (which is a value acquired from the machining program information storage region 20) at which images of the machining programs, displayed by the machining program list display unit 10, are switched and displayed.

Displayed in a column of “currently-displayed image” is identification information of image data which is associated with a machining program currently displayed by the machining program list display unit 10.

Further, displayed in a column of “number of images” is the number of pieces of image data (which is a value acquired from the machining program information storage region 20 when the display management table 21 is created) associated, on the machining program information storage region 20, with a machining program displayed by the machining program list display unit 10.

The display switch instruction unit 11 acquires current time from the clock unit 12 and refers to the display management table 21 in each control cycle so as to determine whether or not the current time is over the switching cycle from previous switching time for each machining program. When it is determined that the current time is over the switching cycle, the display switch instruction unit 11 instructs the machining program list display unit 10 to switch a currently-displayed image of a corresponding machining program to a next image of the currently-displayed image. When there is not a next image of the currently-displayed image, that is, when an index of identification information of an image which is set as the currently-displayed image accords with a value which is set as the number of images, the display switch instruction unit 11 instructs the machining program list display unit 10 to return the image to the first image among a plurality of images which are associated with the corresponding machining program.

Then, with respect to the information related to the machining program in the display management table 21, to which switching is performed, data in the column of “previous switching time” is updated to current time and data in the column of “currently-displayed image” is updated to identification information of an image which is a switching destination.

For example, in the display management table 21 of FIG. 4, the machining program list display unit 10 displays image 1 (the first image) for current machining program O0002 and last update time of image display for the machining program O0002 is 09:12:11.000. The switching cycle of the machining program O0002 is 1000 milliseconds. Therefore, the display switch instruction unit 11 instructs the machining program list display unit 10 to switch the image of the machining program O0002 to image 2 when the current time passes 09:12:12.000.

Then, in the display management table 21 related to the machining program O0002, data in the column of “previous switching time” is updated to the current time and data in the column of “currently-displayed image” is updated to image 2.

On the other hand, the machining program list display unit 10 displays image 8 which is the eighth image for current machining program O0003 and last update time of image display for the machining program O0003 is 09:12:11.700. The switching cycle of the machining program O0003 is 300 milliseconds. Therefore, the display switch instruction unit 11 tries to provide an instruction of image switching to the machining program list display unit 10 when the current time passes 09:12:12.000. However, the number of images is only eight (image 1 to image 8), so that the display switch instruction unit 11 instructs the machining program list display unit 10 to return the image for the machining program O0003 to image 1 (the first image).

Then, in the display management table 21 related to the machining program O0003, data in the column of “previous switching time” is updated to the current time and data in the column of “currently-displayed image” is updated to image 1.

Thus, in the numerical controller 1 according to the present embodiment, machining programs which are stored in the machining program information storage region 20 are displayed by the machining program list display unit 10 and images which are displayed together with program names and the like of respective machining programs are switched in each set cycle and displayed under display cycle management by the display switch instruction unit 11.

With respect to each machining program, images of a workpiece are taken in a stepwise manner in machining based on the corresponding machining program so as to be stored in a state where the image data is associated, as image data, with the corresponding machining program in advance. Accordingly, when a list of the machining program is displayed later, a user can browse a machined state of the workpiece which is a machining object in execution of the corresponding machining program as image animation so as to be able to grasp contents of the machining program at a glance. Further, a similar advantageous effect can be obtained by preparing a tool path, an operation of a machine, and the like as images.

The embodiment of the present invention is described above. However, the present invention is not limited only to the example of the above-described embodiment and the present invention can be embodied in various aspects by adding arbitrary alterations.

For example, previous switching time and a switching cycle are managed for each machining program in the above-described embodiment. However, such configuration may be employed that switching cycles of all machining programs are unified so as to perform display management of images of all machining programs by single previous switching time and single switching cycle.

In the above-described embodiment, the machining program list display unit 10 and the display switch instruction unit 11 are provided as separate function means, but the display switch instruction unit 11 may be implemented as one subordinate function of the machining program list display unit 10.

Further, the function of the present invention is described by taking the list display as an example in the above-described embodiment. However, the advantageous effect of the present invention can be exhibited by displaying images which are periodically switched according to the present invention together with information related to a corresponding machining program on a detail display screen on which information of a single machining program is displayed.

Furthermore, the machining program information and the display management table which are described in the above-described embodiment are examples, and items provided to these pieces of information and data structures can be arbitrarily changed within a scope in which the object of the present invention can be achieved.

1: A numerical controller having a function of displaying a machining program, comprising:
a machining program data storage region which stores data related to the machining program and a plurality of image data related to machining control based on the machining program in a manner such that the data related to the machining program and the image data related to machining control are associated with each other;
a machining program display unit which displays data which is related to the machining program and is stored in the machining program data storage region and at least one of the image data which are associated with the machining program; and
a display switch instruction unit which instructs to switch the image data displayed on the machining program display unit in a predetermined cycle; wherein
the machining program display unit is configured to switch image data displayed in response to an instruction from the display switch instruction unit.

2: A numerical controller having a function of displaying a list of a machining program, comprising:
a machining program data storage region which stores data related to the machining program and a plurality of image data related to machining control based on the machining program in a manner such that the data related to the machining program and the image data related to machining control are associated with each other;
a machining program list display unit which displays a list of data which is related to the machining program and is stored in the machining program data storage region and at least one of image data which are associated with the machining program; and
a display switch instruction unit which instructs to switch the image data displayed on the machining program list display unit in a predetermined cycle; wherein
the machining program list display unit is configured to switch image data displayed in response to an instruction from the display switch instruction unit.

3: The numerical controller according to claim 2, wherein
a cycle for switching the image data is further stored in the machining program data storage region in a state where it is associated with the machining program, and
the display switch instruction unit instructs to switch the image data displayed in the machining program list display unit based on the cycle for switching the image data which is associated with the machining program.

4: The numerical controller according to claim 1, wherein the image data are image data of a workpiece which is machined based on the machining program, image data of a tool path which is controlled by the machining program, or image data of an object which is controlled by the machining program.

5: The numerical controller according to claim 2, wherein the image data are image data of a workpiece which is machined based on the machining program, image data of a tool path which is controlled by the machining program, or image data of an object which is controlled by the machining program.

6: The numerical controller according to claim 3, wherein the image data are image data of a workpiece which is machined based on the machining program, image data of a tool path which is controlled by the machining program, or image data of an object which is controlled by the machining program.
